(19) United States
(12) Patent Application Publication
(10) Pub. No.: US 2020/0070266 A1
(43) Pub. Date: Mar. 5, 2020

(54) RETENTION APPARATUS FOR MATERIAL REMOVAL MACHINES

(71) Applicant: ILLINOIS TOOL WORKS INC., Glenview, IL (US)

(72) Inventor: Bryan John Kordus, Twin Lakes, WI (US)

(21) Appl. No.: 16/459,032

(22) Filed: Jul. 1, 2019

Related U.S. Application Data
(60) Provisional application No. 62/724,277, filed on Aug. 29, 2018.

(51) Int. Cl. B23D 61/02; B26D 7/18

(52) U.S. Cl. CPC B23D 61/025; B28D 1/04; B26D 7/18

(57) ABSTRACT

Retention apparatus and systems for material removal machines are disclosed. In some examples, a material removal machine having a material removal tool (e.g., a saw blade, an abrasive saw, a polisher, a grinder, and/or more general material preparation and/or testing tool) is secured to a spindle using a spring loaded nut. The spring loaded nut of the present disclosure self-tightens when the material removal tool is rotated. Additionally, the spring loaded nut requires a smaller force to attach and/or remove the spring loaded nut, allowing for tool-less and/or low torque attachment and/or removal.

### CROSS REFERENCE TO RELATED APPLICATIONS

This application claims priority from and the benefit of U.S. Provisional Application Ser. No. 62/724,277, entitled “RETENTION APPARATUS FOR MATERIAL REMOVAL MACHINES,” filed Aug. 29, 2018, the entirety of which is hereby incorporated by reference.

### TECHNICAL FIELD

The present disclosure generally relates to material removal machines and, more particularly, to retention mechanisms for material removal machines.

### BACKGROUND

Conventional material removal tools, such as saws, grinders, and/or polishers, for example, are retained on a spindle by a bolt. Such a bolt requires one or more tools to secure the bolt onto the spindle, as well as one or more tools to remove the bolt from the spindle. For example, a spindle lock and/or wrench may be required to hold the spindle, while another wrench may be required to tighten the bolt. Additionally, bolts sometimes loosen during rotation of the material removal tool, or tighten such that removal of the bolt becomes very difficult.

Limitations and disadvantages of conventional and traditional approaches will become apparent to one of skill in the art, through comparison of such systems with the present disclosure as set forth in the remainder of the present application with reference to the drawings.

### SUMMARY

The present disclosure is directed to retention apparatus for material removal machines, for example, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 is a perspective view of an example material removal system, in accordance with aspects of this disclosure.

FIG. 2 is a rear perspective view of an example material removal assembly.

FIG. 3a is an enlarged rear perspective view of an example material removal machine of the material removal assembly of FIG. 2, in accordance with aspects of this disclosure

FIG. 3b is a side view of an example material removal machine of the material removal assembly of FIG. 1, with some portions cut away for clarity, in accordance with aspects of this disclosure.

FIG. 3c is an opposite side view of the example material removal machine of FIG. 3b, in accordance with aspects of this disclosure.

FIG. 3d is a cross-section along line 3d-3d in FIG. 3b, in accordance with aspects of this disclosure.

FIG. 3e is an enlarged portion of the cross-section of FIG. 3d, in accordance with aspects of this disclosure.

FIG. 4a is a perspective view of a spring loaded nut, in accordance with aspects of this disclosure.

FIG. 4b is an exploded view of the spring loaded nut of FIG. 4a, in accordance with aspects of this disclosure.

FIG. 4c is a cross section of the spring loaded nut of FIG. 4a, along the line 4c-4c in FIG. 4a, in accordance with aspects of this disclosure.

The figures are not necessarily to scale. Where appropriate, the same or similar reference numerals are used in the figures to refer to similar or identical elements. For example, reference numerals utilizing lettering (e.g., upper support rail 202a, lower support rail 202b) refer to instances of the same reference numeral that does not have the lettering (e.g., support rails 202).

### DETAILED DESCRIPTION

Preferred examples of the present disclosure may be described hereinbelow with reference to the accompanying drawings. In the following description, well-known functions or constructions are not described in detail because they may obscure the disclosure in unnecessary detail. For this disclosure, the following terms and definitions shall apply.

As used herein, the terms “about” and/or “approximately,” when used to modify or describe a value (or range of values), position, orientation, and/or action, mean reasonably close to that value, range of values, position, orientation, and/or action. Thus, the examples described herein are not limited to only the recited values, ranges of values, positions, orientations, and/or actions but rather should include reasonably workable deviations.

As used herein, the terms “coupled,” “coupled to,” and/or “coupled with,” each mean a structural and/or electrical connection, whether attached, affixed, connected, joined, fastened, linked, and/or otherwise secured. The term “attach” means to affix, couple, connect, join, fasten, link, and/or otherwise secure. The term “connect,” means to attach, affix, couple, join, fasten, link, and/or otherwise secure.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

Some examples of the present disclosure relate to a material removal machine, comprising a spindle, an adapter coupled to the spindle, and spring loaded nut manually coupled to the adapter, the spring loaded nut securing a material removal tool on the spindle.

Some examples of the present disclosure relate to a material removal system, comprising a movable assembly, and a material removal machine configured for movement via the movement assembly, the material removal machine comprising a spindle, an adapter coupled to the spindle, and a spring loaded nut manually coupled to the adapter, the spring loaded nut securing a material removal tool on the spindle.

In some examples, an adapter end of the spindle comprises a cavity encircled by a coupling surface, the adapter coupled to the spindle at the coupling surface. In some examples, the spindle is configured to rotate at the urging of a pulley, the spindle having a first spindle portion retained by the pulley and a second spindle portion spaced from the pulley, the second spindle portion including the adapter end. In some examples, adapter comprises a base and a neck, the base having a complementary coupling surface coupled to the coupling surface of the spindle, and the neck extending from the base and having an engaging surface engaged to a complementary engaging surface of the spring loaded nut. In some examples, the material removal machine further comprises a first flange and a second flange, the spindle extending through the first flange and the second flange, and the material removal tool positioned between the first flange and the second flange. In some examples, the spring loaded nut abuts the second flange so as to secure the material removal tool between the first flange and the second flange. In some examples, the spindle includes a spindle shoulder, the first flange abutting the spindle shoulder. In some examples, the spring loaded nut comprises an internal spring mechanism that enables the spring loaded nut to self-tighten when the material removal tool is spun via the spindle, and enables tool less removal of the spring loaded nut when the material removal tool is stationary. In some examples, the spring loaded nut includes an outer collar, an inner body having engagement features configured for coupling to the adapter, and a tray, the internal spring mechanism translating torque applied to the outer collar to the inner body through the tray when the outer collar is turned in at least one direction. In some examples, the material removal tool comprises a cutting tool, a grinding tool, or a polishing tool.

Some examples of the present disclosure relate to a material removal machine having a material removal tool (e.g., a saw blade, an abrasive saw, a polisher, a grinder, and/or more general material preparation and/or testing tool) secured to a spindle using a spring loaded nut. In conventional systems, material removal tools are sometimes secured to a spindle with bolts or conventional nuts. However, bolts and/or conventional nuts require additional tools (e.g., wrenches, spindle locks, etc.) to attach and/or remove the bolts and/or nuts from the spindle. Additionally, the bolts and/or nuts sometimes loosen when the spindle and/or material removal tool are rotated. In contrast, the spring loaded nut of the present disclosure may be manually attached and/or removed from the spindle, with no additional tools. Further, the spring loaded nut self-tightens when the material removal tool is rotated. Additionally, the spring loaded nut requires a smaller force to attach and/or remove the spring loaded nut, allowing for tool-less and/or low torque attachment and/or removal.

While the spring loaded nut is available from retailers for use with some hand-held products, the present disclosure contemplates adapting larger, non-hand held, material removal machines for use with the spring-loaded nut. Additionally, the adaptations are easily reversible, such that legacy operators may instead use more familiar methods of retention (e.g., bolts) with minimal modification to the machine.

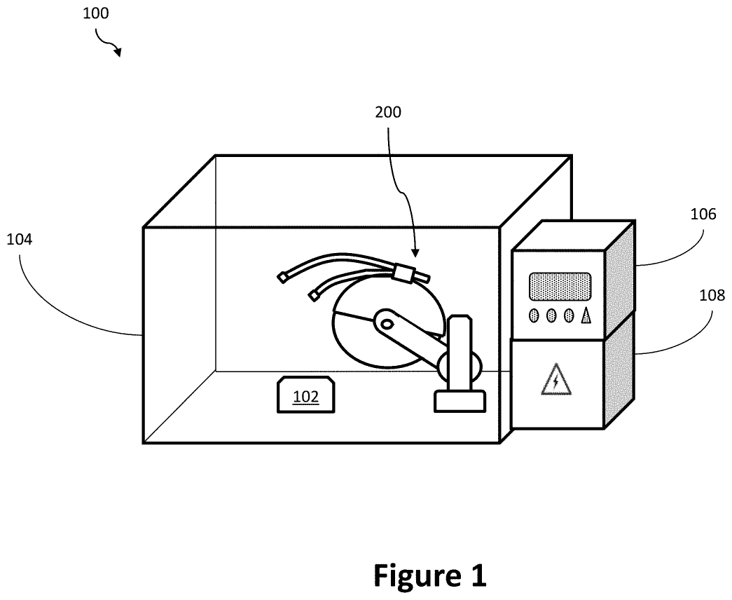

FIG. 1 shows a simplified illustration of an example material removal system 100. As shown, the material removal system 100 includes a material removal assembly 200 and a table 102 substantially enclosed within a cabinet 104 (and/or housing). The table 102 is configured to retain a material sample (not shown), upon which the material removal assembly 200 may operate. In the example of FIG. 1, the material removal assembly 200 further includes a user interface (UI) 106 and a power source 108.

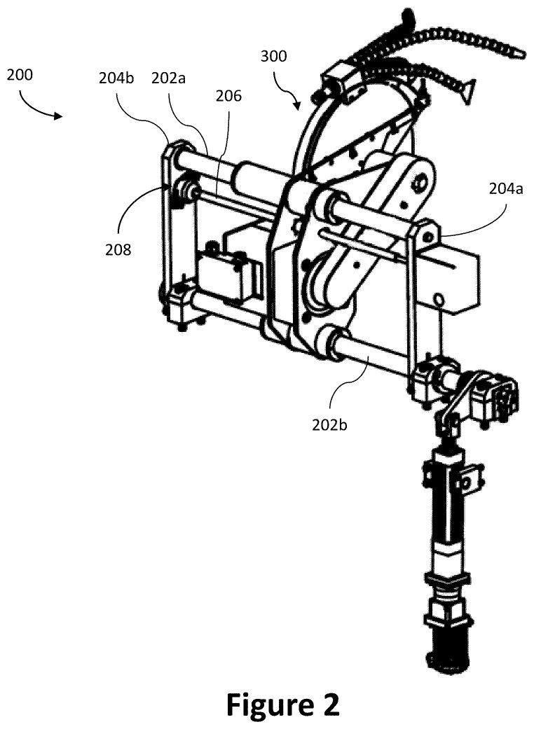

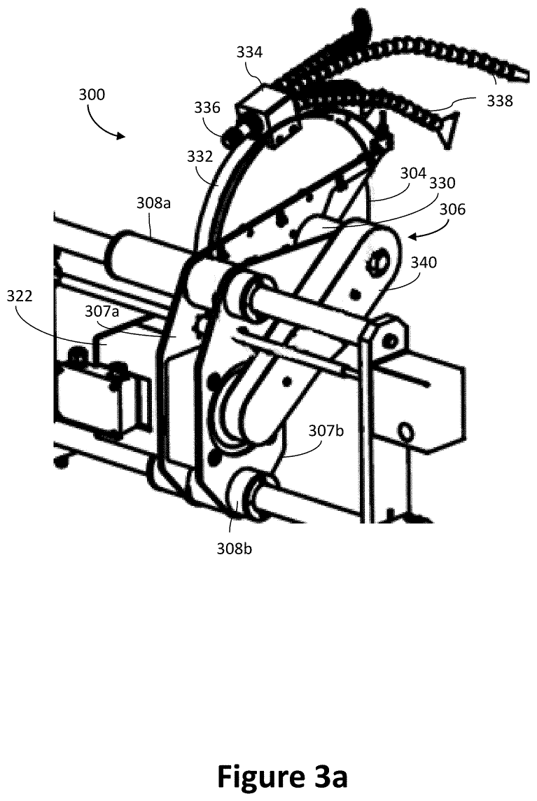

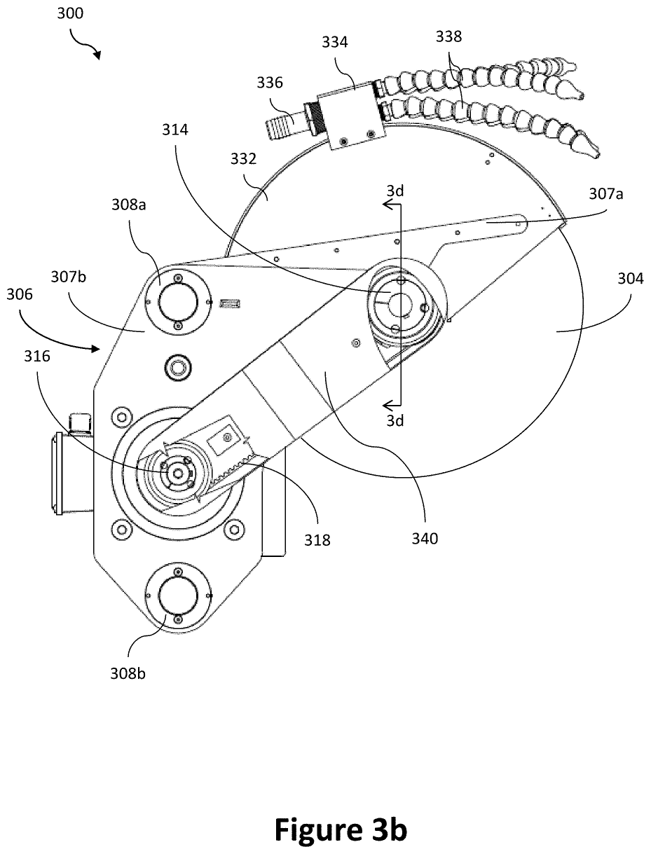

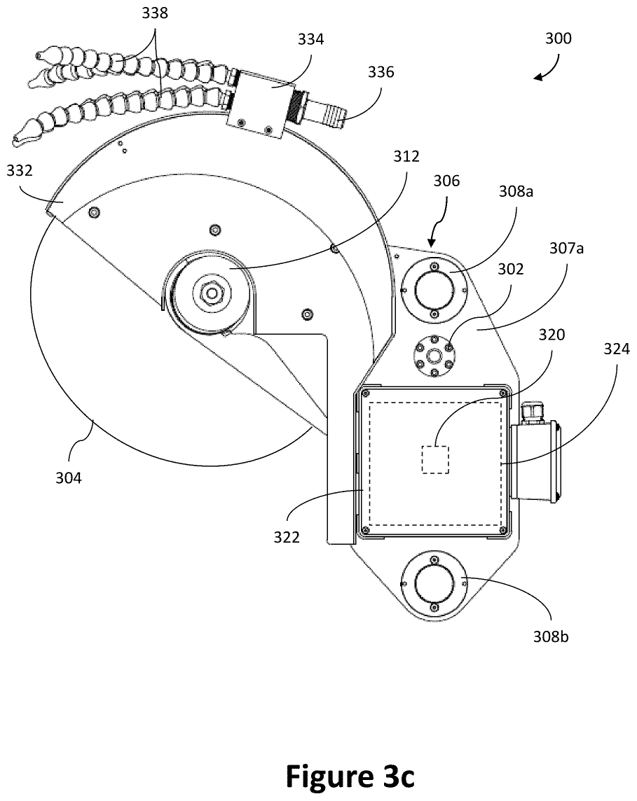

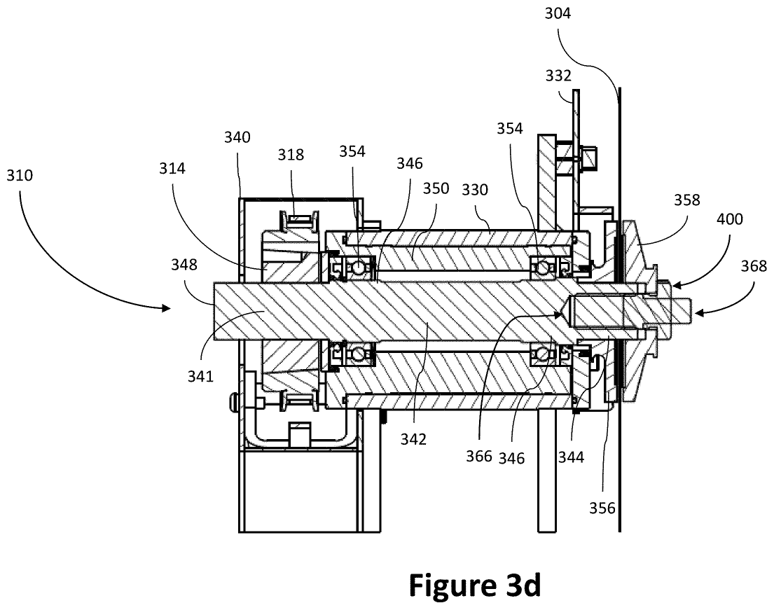

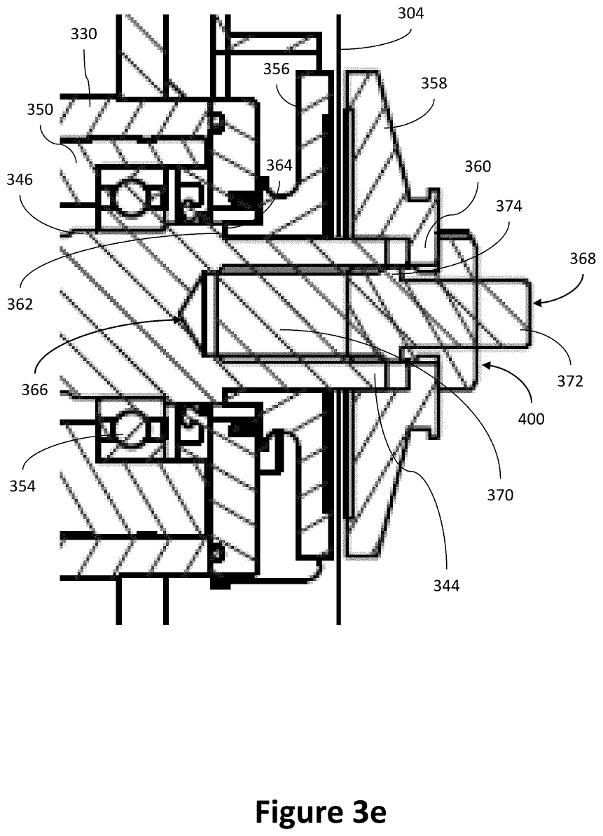

FIG. 2 shows a rear perspective view of an example material removal assembly 200. In the example of FIG. 2, the material removal assembly 200 includes a material removal machine 300. As shown, the material removal machine is retained on an upper support rail 202a and a lower support rail 202b between a first end plate 204a and a second end plate 204b. The support rails 202 extend through the material removal machine 300 and are retained by the end plates 204. More particularly, the support rails 202 extend through sleeves 308 of the material removal machine 300 (see, e.g., FIG. 3a). An actuation shaft 206 also extends between the end plates 204 and through the material removal machine 300. More particularly, the actuation shaft 206 extends through an actuation nut 308 of the material removal machine 300 (see, e.g., FIG. 3c). Though not shown, the actuation shaft 206 may include engagement features, such as screw threads, for example. The engagement features may engage with complementary engagement features (e.g., threaded grooves) of the actuation nut 302 of the material removal machine 300. As shown, the actuation shaft 206 is positioned vertically between the support rails 202 and rotatably attached to the second end plate 204b. More particularly, the actuation shaft 206 is attached to the second end plate 204b at a bearing 208. The bearing 208 is configured to retain an end of the actuation shaft 206 to the second end plate 204b, while allowing the actuation shaft 206 to rotate within the bearing 208. The other end of the actuation shaft 206 is rotatably attached to the first end plate 204a.

FIGS. 3a-3d show various views of the material removal machine 300. FIG. 3a is an enlarged rear perspective view, while FIGS. 3b and 3c are side views of the material removal machine 300, with some of the other elements of the material removal assembly 200 removed for the sake of clarity. As shown, the material removal machine 300 includes a material removal tool 304 (e.g., a saw blade, abrasive saw, grinder, polisher, etc.) coupled to a support 306. In the example of FIGS. 3a-3d, the material removal tool 304 is a disc. In some examples, the material removal tool 304 may be an approximately 16 inch diameter disc, an approximately 17 inch diameter disc, an approximately 18 inch diameter disc, an approximately 19 inch diameter disc, or an approximately 20 inch diameter disc.

In the example of FIG. 3a, the support 306 comprises two substantially parallel support plates 307: a first support plate 307a and a second support plate 307b. The support plates 307 are connected through the sleeves 308 (upper sleeve 308a and lower sleeve 308b), a spindle housing 330, and a tool actuator housing 322. The tool actuator housing 322 encloses a tool actuator 320 and/or tool actuator controller 324, as further discussed below. The spindle housing 330 encloses at least a portion of a spindle 310, upon which the material removal tool 300 is secured. The sleeves 308 are attached to and/or extend through the support plates 307. The sleeves 308 further encircle portions of the support rails 202. This allows the sleeves 308 to guide the material removal machine 300 along the support rails 202 when the actuator shaft 206 moves the material removal machine linearly, and further retains the material removal machine 300 on the support rails when the support rails 202 are moved rotatably.

In the examples of FIGS. 3a-3d, the material removal machine 300 further includes a shield 332 connected to the support plate 307a. The shield 332 partially encloses (and/or encases) the material removal tool 300. A coolant manifold 334 is attached to an upper portion of the shield 332. As shown, the coolant manifold 334 includes a coolant inlet 336 in fluid communication with several coolant outlets 338. The support plate 307a also includes the nut 302. The material removal tool 304 is coupled to the support 306 via a spindle 310, as shown, for example, in FIGS. 3d-3e.

As shown in the example of FIGS. 3a-3e, the spindle 310 extends through a center (and/or central aperture) of the material removal tool 304. As shown, the spindle 310 is substantially cylindrical. In the example of FIG. 3d, the spindle 310 also extends through a center (and/or central aperture) of a spindle pulley 314. When the spindle pulley 314 turns, the spindle pulley 314 engages (and/or urges, moves, forces, acts on, etc.) the spindle 310 to turn the spindle 310 and the material removal tool 304.

In the example of FIG. 3b, an actuator pulley 316 is mechanically connected to the spindle pulley 314 via a belt 318, such that the belt 318 translates rotation of the actuator pulley 316 into rotation of the spindle pulley 314. As shown, the actuator pulley 316 is mechanically connected to a tool actuator 320 (e.g., an electrical motor) configured to turn the actuator pulley. In the examples of FIGS. 3b and 3d, the actuator pulley 316, belt 318, and spindle pulley 314 are encased within an arm 340 of the support 306. In the example of FIG. 3b, the tool actuator 320 is encased in the tool actuator housing 322 of the support 306. In some examples, the tool actuator 320 may be a servo motor. As shown, a tool actuator controller 324 is also encased within the actuator housing 322. In some examples, the tool actuator controller 324 may be otherwise positioned. The tool actuator controller 324 is in electrical communication with the tool actuator 320. The tool actuator 320 is configured to turn the actuator pulley 316 in response to input (e.g., one or more control signals) from the tool actuator controller 324. When turned, the belt 318 translates rotation of the actuator pulley 316 into rotation of the spindle pulley 314, and the spindle 310 translates rotation of the spindle pulley 314 into rotation of the material removal tool 304.

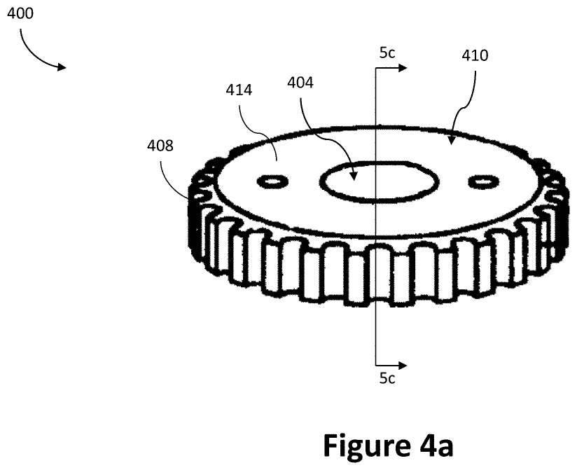

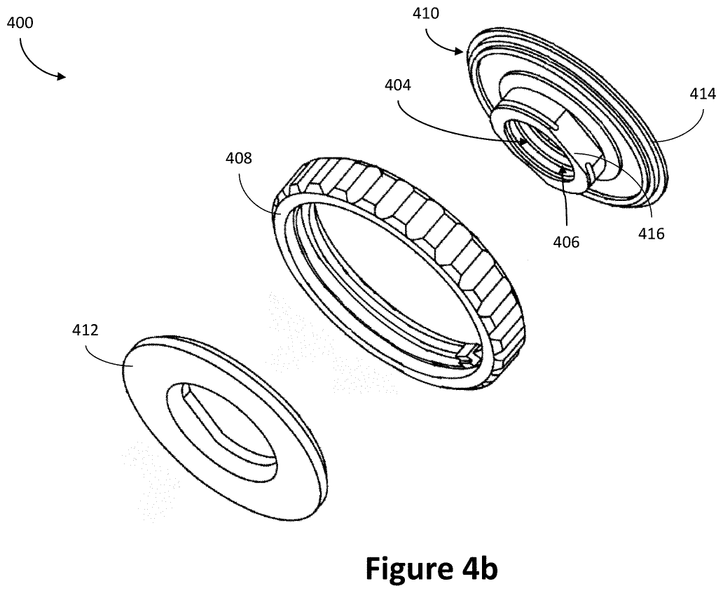

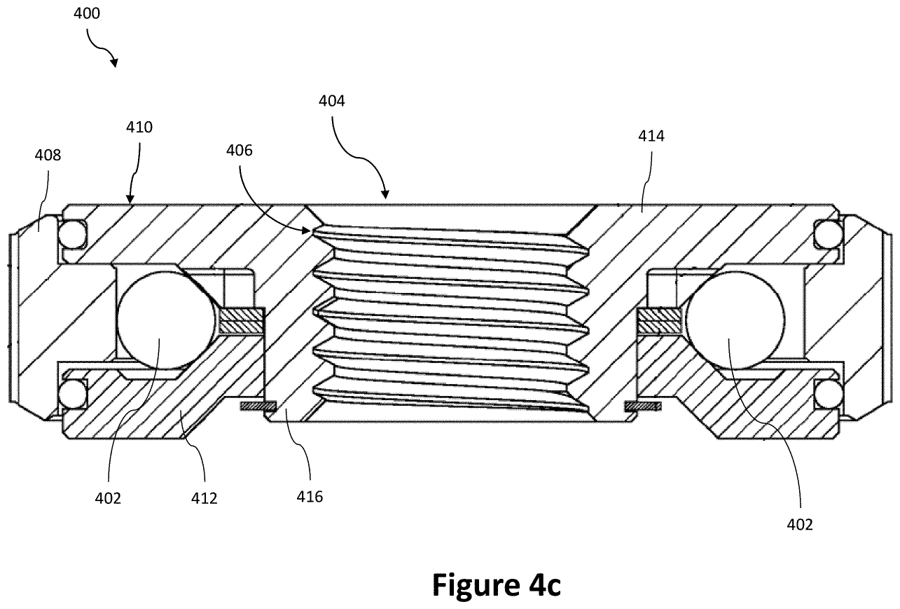

As shown in the examples of FIGS. 3d-4, the spindle includes a rear portion 341, a central portion 342, and a front portion 344. As shown, raised portions 346 of the spindle 310 separate the central portion 342 from the rear portion 341 and front portion 344. The diameter of the spindle 310 is greater at the raised portions 346 than at other portions of the spindle 310. In the example of FIG. 3d, the rear portion 341 of the spindle 310 extends through an approximate center of the spindle pulley 314, which is encased within the arm 340. An end 348 of the rear portion 341 also extends out of the arm 340. The spindle pulley 314 maintains a frictional grip on the rear portion 341 of the spindle 310, such that rotation of the spindle pulley 314 is translated into rotation of the spindle 310.

In the example of FIG. 3d, the central portion 342 of the spindle 310 extends through a hub 350 and a spindle housing 330. Ball bearings 354 encircle the spindle 310, between the hub 350 and the raised portions 346 of the spindle 310. As shown, a front portion 344 of the spindle 310 extends through a center (and/or central aperture) of the material removal tool 304. The front portion 344 also extends through a center (and/or central aperture of an inner flange 356. The central aperture of the inner flange 356 is sized to have a diameter just slightly larger than the diameter of the front portion 344 of the spindle 310, such that the spindle 310 can fit through the central aperture, and still frictionally engage the inner flange 356.

The inner flange 356 interoperates with an outer flange 358 to retain the material removal tool 304 on the spindle 310 by squeezing (and/or sandwiching) the material removal tool 304 between the inner flange 356 and outer flange 358. In the example of FIGS. 3d and 3e, the front portion 344 of the spindle 310 does not extend through a center (and/or central aperture) of the outer flange 358. Rather, the outer flange 358 includes a ledge 360 that narrows the diameter of its central aperture, such that the ledge 360 prohibits the spindle 310 from extending through the central aperture of the outer flange.

In the example of FIGS. 3d and 3e, the inner flange 356 abuts the front portion 344 of the spindle 310. More particularly, the front portion 344 of the spindle 310 includes a spindle shoulder 362 that abuts a flange shoulder 364 of the inner flange 356 to stop the inner flange 356 from moving farther along the spindle 310. In the example of FIG. 3e, the spindle shoulder 362 comprises an edge where the spindle 310 transitions from the raised portion 346 to the front portion 344. As shown, the spindle shoulder 362 and flange shoulder 364 are substantially annular.

In the example of FIGS. 3d and 3e, the rear portion 341 and central portion 342 of the spindle 310 are substantially solid. However, the front portion 344 of the spindle 310 includes a cavity 366. As shown, the cavity 366 is approximately cylindrical, with a portion that is approximately conical. The internal surface of the spindle 310 surrounding the cavity 366 includes engagement features, such as threaded grooves, for example. As shown, an adapter 368 is fitted inside the cavity 366.

In the example of FIGS. 3d and 3e, the adapter 368 includes a base 370 and a neck 372. As shown, both the base 370 and the neck 372 are substantially solid and substantially cylindrical. The diameter of the base 370 is larger than the diameter of the neck 372. However, the diameter of the base 370 is slightly less than the diameter of the cavity 366, such that the base 370 fits snugly within the cavity 366.

In the example of FIGS. 3d and 3e, an annular ridge 374 separates the base 370 and neck 372. As shown, the annular ridge 374 has a diameter that is greater than both the base 370 and the neck 372. Nevertheless, the diameter of the adapter 368 at the annular ridge 374 is still less than the diameter of the central aperture of the outer flange 358, such that the ledge 360 can fit over the annular ridge 374.

In the example of FIGS. 3d and 3e, both the base 370 and the neck 372 of the adapter 368 are configured with engagement features, such as screw threads, for example. The engagement features of the base 370 engage with the engagement features of the spindle 310 surrounding the cavity 366, so as to couple the adapter 368 to the front portion 344 of the spindle 310. In some examples, the base 370 and/or the spindle 310 surrounding the cavity 366 may include no engagement features, and may instead rely on a frictional fit. In some examples, the adapter 368 may use a frictional fit between the base 370 and/or the spindle 310 surrounding the cavity 366, and the engagement features may be features to improve this frictional fit, such as knurling, ridges, and/or other friction increasing features, for example. In some examples, the spindle 310 itself may include engagement features to engage with the complementary engagement features of a spring loaded nut 400, and/or the adapter 368 may be omitted.

In the example of FIGS. 3d and 3e, a spring loaded nut 400 is attached to the neck 372 of the adapter 368 to secure the material removal tool 304 on the spindle 310. FIGS. 4a-4c show examples of the spring loaded nut 400. In some examples, the spring loaded nut 400 includes an internal spring mechanism 402 that enables the spring loaded nut 400 to self-tighten when the material removal tool 304 is spun via the spindle 310, and enables tool less removal of the spring loaded nut 400 when the material removal tool is stationary.

As shown, the spring loaded nut 400 includes a central aperture 404 through which the neck 372 of the adapter 368 extends. The central aperture 404 has a diameter slightly larger than the diameter of the neck 372 of the adapter 368, such that the neck 372 snugly fits within the central aperture 404 of the spring loaded nut 400. The diameter of the central aperture 404 is smaller than the diameter of the ridge 374 of the adapter 368, however. Thus, the spring loaded nut 400 can advance on the adapter 368 no further than the ridge 374. In some examples, the ridge 374 may be removed, and the spring loaded nut 400 may be allowed to advance all the way to the edge of the adapter 368.

In the example of FIGS. 4b and 4c, the spring loaded nut 400 includes engagement features 406 surrounding the central aperture 404 of the spring loaded nut 400. In some examples, the engagement features of the spring loaded nut 400 are complementary to those of the neck 372. In the example of FIGS. 4b and 4c, the engagement features 406 are screw threads. In some examples, the engagement features 406 may be features to improve frictional fit, such as knurling, ridges, and/or other friction increasing features, for example.

In the examples of FIGS. 4a-4c, the spring loaded nut 400 is annular. As shown, the spring loaded nut 400 includes an outer collar 408, an inner body 410 fit within the collar 408, and a tray 412 extending from the collar 408. As shown, the collar 408 is substantially annular, with grooves formed into the collar 408 to improve grip. The body 410 is secured within the collar 408. The body 410 comprises an annular disc portion 414 with a central aperture 404. The body 410 narrows from the disc portion 414 to a central column 416 that extends from the disc portion 414. The central aperture 404 extends through the central column 416, which surrounds the central aperture 404. The central column 416 extends through the spring loaded nut 400.

The narrowing of the body 410 from a disc portion 414 with a diameter approximately equal to an inner diameter of the collar 408 to a column 416 with a smaller diameter leaves space within collar 408. The tray 412 is positioned within this space. The collar 408 interfaces with the tray 412, such that rotation of the collar 408 rotates the tray 412. The tray 412, in turn, interfaces with the body 410, such that rotation of the tray imparts rotational force upon the body 410.

In some examples, the interfacing between the collar 408 and the tray 412, and/or between the tray 412 and the body 410, is facilitated through one or more spring mechanisms 402. In the example of FIG. 4c, the spring mechanism 402 is illustrated as being an annular spring. In some examples, the spring mechanism 402 may instead be a coiled compression spring, a torsion spring, a leaf spring, and/or some other appropriate spring.

In some examples, the spring mechanisms 402 are such that rotation of the collar 408 may not immediately result in rotation of the body 410. For example, the body 410 may be tightly secured in place on the adapter 368 via the engagement features 406 of the central aperture 404, such that an instant force (and/or torque) upon the collar 408 may be too little to dislodge the body 410. However, continued rotational force (e.g., torque) applied to the collar 408 may cause movement of the collar 408, even if the tight securement of the body 410 on the adapter 368 via the engagement features 406 prevents movement of the body 410. This continued movement of the collar 408, and continued non-movement of the body 410, may result in compression of the spring mechanisms 402 that serve as the interface between the collar 408, the tray 412, and the body 410.

When compressed, the spring mechanisms 402 have spring force. The rotation of the collar 408 (and/or tray) may cause compression in the one or more spring mechanisms 402, thereby allowing for spring force to build up and be applied to the body 410. This built up spring force may be greater than the rotational force (and/or torque) that could be applied otherwise, especially without the aid of a tool, and may subsequently dislodge the body 410. Further, no tool may be needed to hold the spindle 310 in place while the collar 408 is turned since the collar 408 is not directly attached to the rest of the spring loaded nut 400. Instead, the minor drag force of the spindle pulley 314 on the spindle 310 may be enough to keep the body 410 in place while the collar 408 is turned, which allows for spring force to be built up. Thus, the spring loaded nut 400 is able to be secured to and/or removed from the adapter 368 without the use of an additional tool.

When the spring loaded nut 400 is secured on the adapter 368, the spring loaded nut 400 pushes (and/or forces, moves, shifts, etc.) the outer flange 358 towards the inner flange 356 (and/or material removal tool 304) on the spindle 310. The force of the spring loaded nut 400 on the outer flange 358 causes the material removal tool 304 to be sandwiched between the outer flange 358 and inner flange 356. Thus, the material removal tool 304 is held in place on the spindle 310 between the outer flange 358 and inner flange 356 by the spring loaded nut 400. The spring loaded nut 400 is secured to the spindle 310 via the adapter 368. The frictional grip of the spindle 310 on the material removal tool 304, as well as the frictional grip of the inner flange 356 and outer flange 358 on the material removal tool 304, forces the material removal tool 304 to turn (and/or spin) when the spindle 310 turns (and/or spins). The low torque requirements of the spring loaded nut 400 allow for easy one handed and/or tool-less removal of the spring loaded nut 400, and thereby easier access to the flanges 356, 358, the spindle, the hub 350, and/or the material removal tool 304. In some examples, the adapter 368 may be removed to allow legacy operators to instead use more familiar methods of retention, such as bolts, for example.

While the present apparatuses, systems, and/or methods have been described with reference to certain implementations, it will be understood by those skilled in the art that various changes may be made and equivalents may be substituted without departing from the scope of the present apparatuses, systems, and/or methods. In addition, many modifications may be made to adapt a particular situation or material to the teachings of the present disclosure without departing from its scope. Therefore, it is intended that the present apparatuses, systems, and/or methods not be limited to the particular implementations disclosed, but that the present apparatuses, systems, and/or methods will include all implementations falling within the scope of the appended claims.

What is claimed is:

1. A material removal machine, comprising:
a spindle;
an adapter coupled to the spindle; and
a spring loaded nut manually coupled to the adapter, the spring loaded nut securing a material removal tool on the spindle.

2. The material removal machine of claim 1, wherein an adapter end of the spindle comprises a cavity encircled by a coupling surface, the adapter coupled to the spindle at the coupling surface.

3. The material removal machine of claim 2, wherein the spindle is configured to rotate at the urging of a pulley, the spindle having a first spindle portion retained by the pulley and a second spindle portion spaced from the pulley, the second spindle portion including the adapter end.

4. The material removal machine of claim 2, wherein the adapter comprises a base and a neck, the base having a complementary coupling surface coupled to the coupling surface of the spindle, and the neck extending from the base and having an engaging surface engaged to a complementary engaging surface of the spring loaded nut.

5. The material removal machine of claim 1, further comprising a first flange and a second flange, the spindle extending through the first flange and the second flange, and the material removal tool positioned between the first flange and the second flange.

6. The material removal machine of claim 5, wherein the spring loaded nut abuts the second flange so as to secure the material removal tool between the first flange and the second flange.

7. The material removal machine of claim 6, wherein the spindle includes a spindle shoulder, the first flange abutting the spindle shoulder.

8. The material removal machine of claim 1, wherein the spring loaded nut comprises an internal spring mechanism that enables the spring loaded nut to self-tighten when the material removal tool is spun via the spindle, and enables tool less removal of the spring loaded nut when the material removal tool is stationary.

9. The material removal machine of claim 8, wherein the spring loaded nut includes an outer collar, an inner body having engagement features configured for coupling to the adapter, and a tray, the internal spring mechanism translating torque applied to the outer collar to the inner body through the tray when the outer collar is turned in at least one direction.

10. The material removal machine of claim 1, wherein the material removal tool comprises a cutting tool, a grinding tool, or a polishing tool.

11. A material removal system, comprising:
a movable assembly; and
a material removal machine configured for movement via the movement assembly, the material removal machine comprising:
a spindle;
an adapter coupled to the spindle; and
a spring loaded nut manually coupled to the adapter, the spring loaded nut securing a material removal tool on the spindle.

12. The material removal system of claim 11, wherein an end of the spindle comprises a cavity encircled by a coupling surface, the adapter coupled to the spindle at the coupling surface.

13. The material removal system of claim 12, wherein the spindle is configured to rotate at the urging of a pulley, the spindle having a first spindle portion retained by the pulley and a second spindle portion spaced from the pulley, the second spindle portion including the end.

14. The material removal system of claim 12, wherein the adapter comprises a base and a neck, the base having a complementary coupling surface coupled to the coupling surface of the spindle, and the neck extending from the base and having an engaging surface engaged to a complementary engaging surface of the spring loaded nut.

15. The material removal system of claim 11, further comprising a first flange and a second flange, the spindle extending through the first flange and the second flange, and the material removal tool positioned between the first flange and the second flange.

16. The material removal system of claim 15, wherein the spring loaded nut abuts the second flange so as to secure the material removal tool between the first flange and the second flange.

17. The material removal system of claim 16, wherein the spindle includes a spindle shoulder, the first flange abutting the spindle shoulder.

18. The material removal system of claim 11, wherein the spring loaded nut comprises an internal spring mechanism that enables the spring loaded nut to self-tighten when the material removal tool is spun via the spindle, and enables tool less removal of the spring loaded nut when the material removal tool is stationary.

19. The material removal system of claim 18, wherein the spring loaded nut includes an outer collar, an inner body having engagement features configured for coupling to the adapter, and a tray, the internal spring mechanism translating torque applied to the outer collar to the inner body through the tray when the outer collar is turned in at least one direction.

20. The material removal system of claim 11, wherein the material removal tool comprises a cutting tool, a grinding tool, or a polishing tool.
